(19) United States
(12) Patent Application Publication
(10) Pub. No.: US 2024/0378667 A1
(43) Pub. Date: Nov. 14, 2024

(54) MULTI-FACTORIAL REAL ESTATE ANALYSIS AND PURCHASING SUPPORT SYSTEM

(71) Applicant: Julio Cesar Roque, Worcester, MA (US)

(72) Inventor: Julio Cesar Roque, Worcester, MA (US)

(21) Appl. No.: 18/518,108

(22) Filed: Nov. 22, 2023

Related U.S. Application Data
(63) Continuation of application No. 17/020,724, filed on Sep. 14, 2020, now abandoned.
(60) Provisional application No. 62/902,231, filed on Sep. 18, 2019.

(51) Int. Cl. G06Q 40/03; G06Q 50/16

(52) U.S. Cl. CPC G06Q 40/03; G06Q 50/167

(57) ABSTRACT

The multi-factorial real estate analysis and purchasing support system disclosed herein allows a buyer to review all of the properties the buyer is able to afford, regardless of the property price but rather it's true payment, and integrate and support all the various stages of the real estate purchasing process. The system provides a digital platform where a buyer tracks the process of its real estate purchase transaction and includes a computation system for determining whether a buyer can or cannot afford to purchase a property separate from a proposed preapproval value. The system further includes a number of networking and referral systems to connect buyers with the appropriate professionals needed to facilitate the purchase transaction, and includes a digital wallet containing financial information to permit the various users to easily transfer funds between one another to pay for various deposits and services.

### CROSS REFERENCE TO RELATED APPLICATIONS

The present application is a Continuation of U.S. Nonprovisional application Ser. No. 17/020,724 filed Sep. 14, 2020, which claims the benefit of U.S. Provisional Application Ser. No. 62/902,231 filed Sep. 18, 2019.

### FIELD

The present system relates generally to real estate software, and more particularly, to a multi-factorial real estate analysis and purchasing support system.

### BACKGROUND

Real estate is property, also known as real property, comprising land, the structures built on and within the land, and any natural resources contained within the boundaries of the property. Residential real estate, in particular, includes structures suitable as a single family or multi-family domicile. Real estate purchases are among the largest transactions most persons will conduct in their lifetime, and the process of purchasing real estate can be very intimidating, especially to those unfamiliar with the rules and requirements.

The real estate purchase process involves a number of steps, each of which may be so distinct as to require separate professionals that specialize in the various steps. An initial step in the purchasing process involves determining the value of a property that a potential buyer can afford, and such a step may be performed by a lender or a loan officer. Such a lender or loan officer can gather and analyze the potential buyer's information and present them with a pre-approval, which usually includes a maximum purchase value for which the buyer is authorized based on a predetermined educated guess.

Once the potential buyer has a pre-approval in hand the buyer may continue the purchase process by searching for properties the buyer can afford. Such searching can be done in multiple ways, though the most common ways include the hiring of a real estate agent or the buyer searching through real estate listings on its own. A number of websites, such as Zillow (a trademark of Zillow, Inc.), Trulia (a trademark of Trulia, Inc.), and Realtor.com (a trademark of National Association of REALTORS), allow potential buyers to browse through homes by setting up search parameters including location, size, bedroom and bathroom count, and listing price.

If a potential buyer finds a property they like, the buyer can either submit a purchase offer or hire a real estate agent to prepare and submit a purchase offer. Such purchase offers have significant legal requirements and may be complicated to prepare, so a potential buyer is often best served by having a professional perform this task on their behalf and represent a buyer's best interests. If the purchase offer is accepted by the seller, the property is then placed in a pending or contingent status, and a number of transaction contingencies may be triggered.

Most common among these contingencies is the finance contingency where an underwriter determines the buyer's ability to financially afford the property. Even after a pre-approval is issued the buyer still risks denial due to property specifics such as property taxes or HOA “Homeowners Association” fees. Other requirements could be such as a home appraisal and the requirement for a home inspection. A home appraisal, which is often required by a lender to confirm the value of the property, is prepared by a licensed appraiser and often involves a walkthrough of the property and comparison with similar recent sales in proximity to the property. A home inspection, which is performed by a licensed home inspector, involves a deep examination of the property in question to determine the condition of the property and assess current or potential damage. The home inspection may be used to acquire homeowner's insurance on the property or may be required by the insurance company before it advances coverage to the buyer. Once the contingencies are completed a clear to close is issued and the property may be transferred to the buyer.

Due to the complexity of financing, it is often difficult for a buyer to know exactly which properties the buyer can afford or to foresee which complications may arise based on a pre-approval letter issued on a mere estimate. This has cost buyers millions of dollars on denied loans based on affordability issues and a flawed system. Yet no solution has been created to protect buyers from this. There are various other stages and parties involved where in fact, a number of real estate transactions can fail as a result of unforeseen circumstances or mistakes made by the buyer or by an agent for the buyer. A number of solutions have been created to avoid such mistakes, such as the development of real estate brokerages that have teams of specialists in-house to handle the various aspects of the transaction process, to the development of websites and software programs that can assist buyers in connecting with appropriate professionals and preparing the required documents.

No solution exists, though, that effectively guides a buyer through the process of finding the best most affordable property once it has been pre-approved for purchase. Due to the way pre-approvals are calculated and presented based on educated guesses, a buyer is often blinded to the fact that said buyer may be able to afford a property worth more than the pre-approved price with yet a lower payment, and may neglect to consider a more appropriate property simply because its listed price is too high. Another adverse situation a buyer might find is a lower priced home could end up being less affordable than a higher priced home due to limitations in today's home buying methods. This could cause underwriting denials and loss of funds to a buyer, causing financial set back and distress.

Therefore, there is a need in the art for a multi-factorial real estate analysis (such as an analysis that takes into consideration a plurality of real estate factors) and purchasing support system that allows a buyer to review the properties said buyer may be able to afford, regardless of the pre-approved price, but rather based on true affordability versus an educated guess and that integrates and supports the various stages of the real estate purchasing process.

### SUMMARY

The illustrative embodiments provide a method, system, and computer program products for a multi-factorial real estate analysis and purchasing support system.

This summary is provided to introduce a selection of concepts in a simplified form that are further described below in the detailed description. This summary is not intended to identify key features of useful features of the claimed subject matter, nor is it intended to be used to limit the scope of the claimed subject matter. Furthermore, the claimed subject matter is not limited to implementations that solve any or some disadvantages noted in any part of this disclosure.

According to illustrative embodiments of the present disclosure, a multi-factorial real estate analysis and purchasing support system is disclosed. In one aspect, the multi-factorial real estate analysis and purchasing support system includes mobile app-based software executed on a computing device, implementing a support system having a database, cloud-based interface, API and involving a plurality of user types and a multi-factorial pre-approval system, as well as a multi-factorial real estate analysis and purchasing support system implementing a multi-factorial property analysis system.

In another aspect, the multi-factorial real estate analysis and purchasing support system may comprise a real estate search engine and a referral system for lenders, real estate agents, appraisers, property inspectors, escrow companies, insurance providers, attorneys, contractors and the like.

In another aspect, the multi-factorial real estate analysis and purchasing support system may comprise a real estate transaction status tracking system.

In another aspect, the present system provides a method of finding properties for purchase based on true affordability, including: computing a complete mortgage payment “Principal, Taxes, Insurance, Private Mortgage Insurance, and HOA”, the costs of obtaining such property such as required down payment and closing costs, escrows and prepaids compared against a buyers income, debt and assets approving the buyer to make offers to purchase real estate only on affordable properties based on that computation; providing a set of real estate listings for which the buyer is approved to make an offer to purchase, avoiding non-affordability errors; providing a second set of real estate listings for which the buyer is not approved to make an offer to purchase; identifying non-affordability reasons in such listings in the second set and modifying such real estate listings in second set to now approved status by changing purchase price or adding seller credits to assist with associated costs; and facilitating the purchase of the property identified in the real estate listing in the second set.

In another aspect, the present system provides a few non-transitory computer readable storage medium of an electronic computing device including instructions embedded thereon which, when executed by the electronic computing device, cause the computing device to find properties for purchase, by: computing a complete mortgage payment “Principal, Taxes, Insurance, Private Mortgage Insurance, and HOA”, the costs of obtaining such property such as required down payment and closing costs, escrows and prepaids, compared against a buyers income, debt and assets and approving the buyer to make offers to purchase real estate based on the computation; providing a first set of real estate listings for which the buyer is approved to make an offer to purchase, avoiding non-affordability errors; providing a second set of real estate listings for which the buyer is not approved to make an offer to purchase; identifying non-affordability reasons in such listings in the second set and modifying such real estate listings in second set to now approved status by changing purchase price or adding seller credits to assist with associated costs; and facilitating the purchase of the property identified in the real estate listing in the second set.

In another aspect, the present system provides a few non-transitory computer readable storage medium of an electronic computing device including instructions embedded thereon which, when executed by the electronic computing device, cause the computing device to not just find properties based on true affordability but also based on lending program guidelines. Such lending programs include but not limited to FHA (Federal Housing Administration), Fannie Mae Products, Freddie Mac Products, USDA (United States Department of Agriculture), and VA (Veterans Affairs) loans. Such integrations are crucial as a buyer may be able to financially afford a property although program guidelines may disqualify said buyer due to high income or loan amounts set by the program guidelines.

In another aspect, the multi-factorial real estate analysis and purchasing support system may comprise a real estate property search engine with full integration of a buyer pre-approval. This allows a buyer to search for property based on true affordability. It allows for a buyer to search based on true payments versus property price as two properties even if priced the same would carry two different payments.

In an aspect herein, a computer-implemented method is provided. The method includes receiving a plurality of properties including at least one traditional property for which the buyer is approved to make a purchase and at least one other property for which the buyer is not approved to make a purchase; defining a real affordability criteria to be satisfied; computing a property specific mortgage payment for each member of the plurality of properties based on corresponding property specific factors in order to determine a total mortgage payment for each property in the plurality of properties; and responsive to determining that said at least one other property for which the buyer is not approved to make a purchase is a real affordable property that meets the real affordability criteria, approving the buyer to make an offer to purchase said real affordable property.

In another aspect herein, one or more of the following steps are provided: (i) wherein defining the real affordability criteria includes computing a maximum mortgage payment based on the buyer's income and wherein the real affordability criteria is met when said total mortgage payment of the real affordable property is equal to or less than the maximum mortgage payment, (ii) wherein defining the real affordability criteria includes obtaining a maximum debt to income ratio and the real affordability criteria is met when the debt to income ratio for the real affordable property is equal or less than the maximum debt to income ratio, (iii) wherein the corresponding property specific factors include principal and interest payment, insurance, property taxes, and mortgage insurance, (iv) wherein the real affordable property saves the buyer more money than the at least one traditional affordable property does, (v) wherein the total mortgage of the real affordable property is modified in order to be less than the maximum mortgage payment, (vi) wherein the modification is achieved by changing a purchase price or adding seller credits, (vii) wherein the buyer is approved to make a purchase of the at least one traditional property based on a on a single, estimate (ix) wherein responsive to computing a maximum mortgage payment or maximum debt to income ratio that satisfies the real affordability criteria, conducting a search for properties of the plurality of properties whose real mortgage payments or real debt to income ratio are equal to or less that the maximum mortgage payment or maximum debt to income ratio respectively.

In yet another embodiment, a computer usable program product comprising a computer readable storage medium including computer usable code for multi-factorial analysis is provided. The computer usable code includes computer usable code for receiving a plurality of properties including at least one traditional property for which the buyer is approved to make a purchase and at least one other property for which the buyer is not approved to make a purchase; computer usable code for defining a real affordability criteria to be satisfied; computer usable code for computing a property specific mortgage payment for each member of the plurality of properties based on corresponding property specific factors in order to determine a total mortgage payment for each property in the plurality of properties; and computer usable code for, responsive to determining that said at least one other property for which the buyer is not approved to make a purchase is a real affordable property that meets the real affordability criteria, approving the buyer to make an offer to purchase said real affordable property.

In an even further illustrative embodiment, a data processing system for multi-factorial analysis may be provided. The data processing system includes a storage device, wherein the storage device stores computer usable program code; and a processor, wherein the processor executes the computer usable program code, and wherein the computer usable program code comprises: computer usable code for receiving a plurality of properties including at least one traditional property for which the buyer is approved to make a purchase and at least one other property for which the buyer is not approved to make a purchase; computer usable code for defining a real affordability criteria to be satisfied; computer usable code for computing a property specific mortgage payment for each member of the plurality of properties based on corresponding property specific factors in order to determine a total mortgage payment for each property in the plurality of properties; and computer usable code for, responsive to determining that said at least one other property for which the buyer is not approved to make a purchase is a real affordable property that meets the real affordability criteria, approving the buyer to make an offer to purchase said real affordable property.

These and other objects, features, and advantages of the present system will become more readily apparent from the attached drawings and the detailed description of the preferred embodiments or examples, which follow.

### BRIEF DESCRIPTION OF THE OF THE DRAWINGS

The novel features believed characteristic of the system are set forth in the appended claims. The system itself, however, as well as a preferred mode of use, further objectives and advantages thereof, will best be understood by reference to the following detailed description of the illustrative embodiments when read in conjunction with the accompanying drawings, wherein:

FIG. 1 schematically presents an overview of a multi-factorial real estate analysis and purchasing support system, in accordance with aspects of the present disclosure;

FIG. 2 illustrates an example single-family property analysis of a multi-factorial real estate analysis and purchasing support system, in accordance with aspects of the present disclosure;

FIG. 3 illustrates an example multi-family property analysis of a multi-factorial real estate analysis and purchasing support system, in accordance with aspects of the present disclosure;

FIG. 4 illustrates an example condominium or coop property analysis of a multi-factorial real estate analysis and purchasing support system, in accordance with aspects of the present disclosure;

FIG. 5 illustrates exemplary buyer search results of a multi-factorial real estate analysis and purchasing support system, in accordance with aspects of the present disclosure;

FIG. 6 schematically presents the stages of a multi-factorial real estate analysis and purchasing support system, in accordance with aspects of the present disclosure;

FIG. 7 schematically presents a computing system configured to carry out and actualize methods and tasks described herein, in accordance with aspects of the present disclosure;

FIG. 8 depicts a block diagram of a network of data processing systems in which illustrative embodiments may be implemented; and

FIG. 9 depicts a block diagram of a data processing system in which illustrative embodiments may be implemented;

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Other implementations described herein as “exemplary” or “illustrative” is not necessarily to be construed as preferred or advantageous over other implementations. The implementations described below are exemplary implementations provided to enable persons skilled in the art to make or use the embodiments of the disclosure and are not intended to limit the scope of the disclosure, which is defined by the claims. Furthermore, there is no intention to be bound by seldom expressed or implied theory presented in the preceding technical field, background, brief summary, or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The multi-factorial real estate analysis and purchasing support system disclosed herein may allow a buyer to review the properties the buyer may be able to afford, regardless of the price, but rather based on property specific payments and integrate and support the various stages of the real estate purchasing process. The system may provide a digital platform where a buyer may track the process of its real estate purchase transaction, and may comprise a computation for determining whether a buyer can or cannot afford to purchase a property separate from a proposed preapproval value.

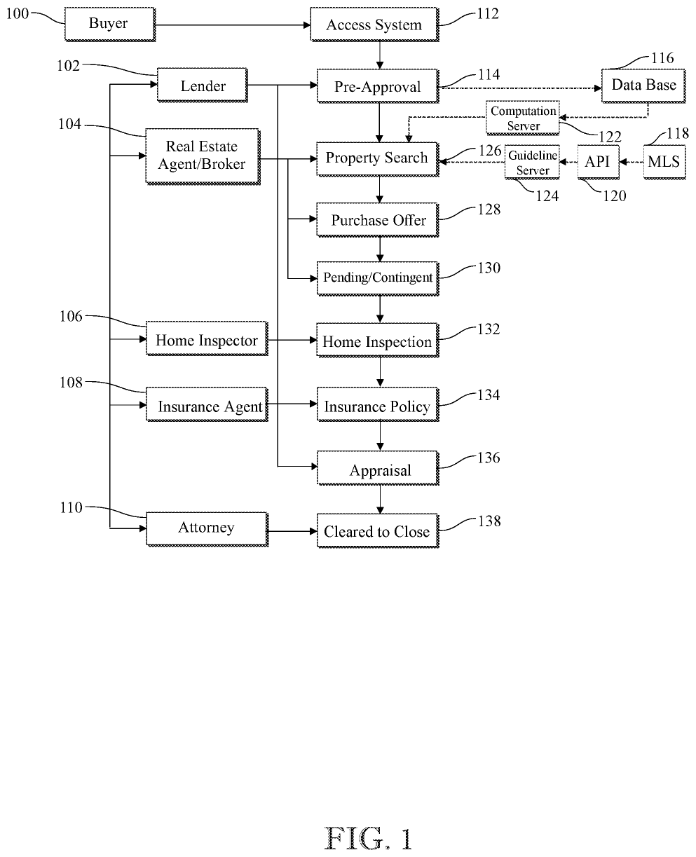

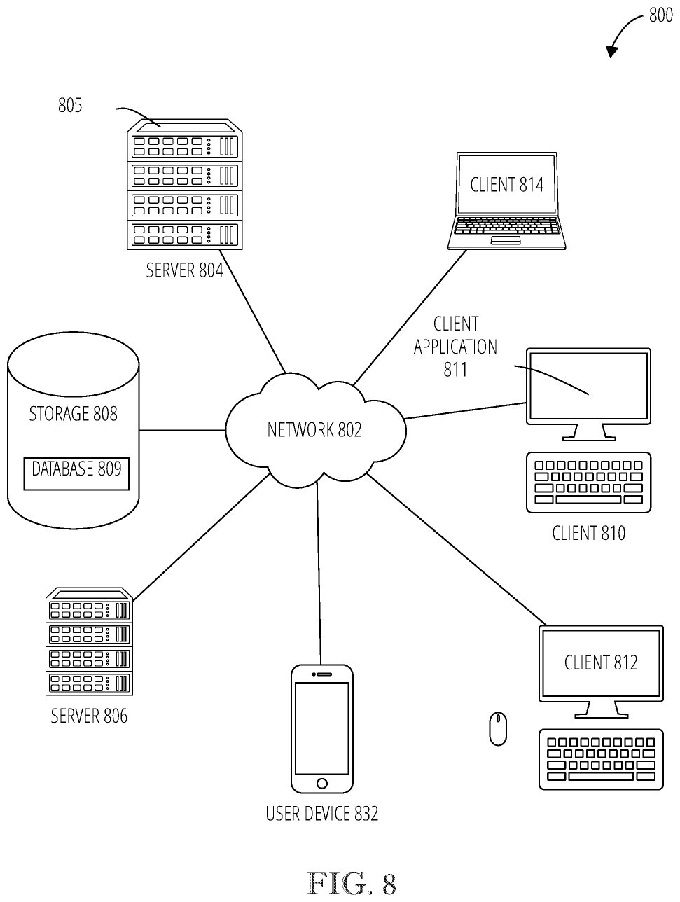

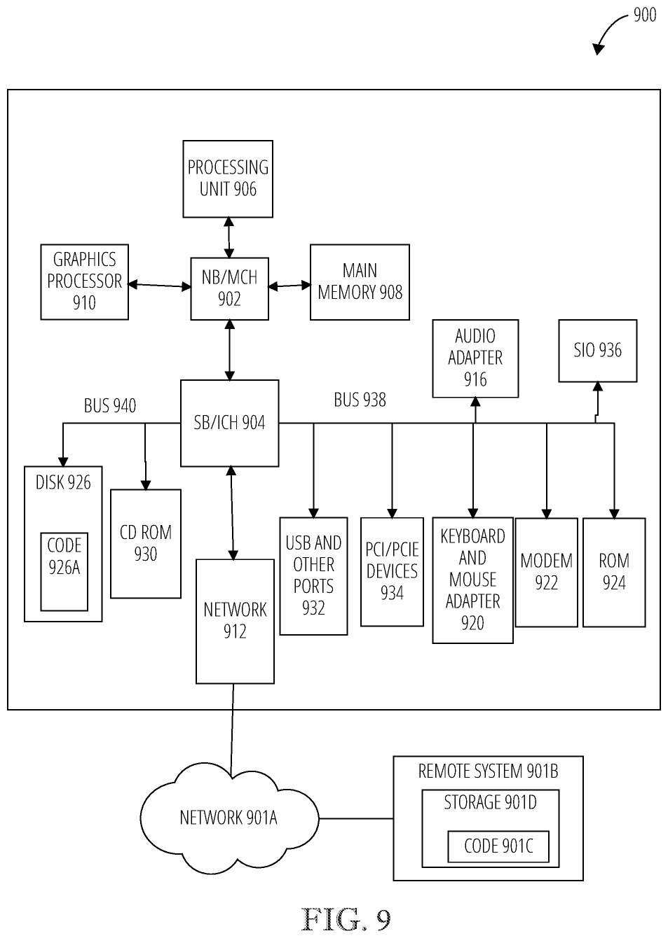

With reference to the figures and in particular with reference to FIG. 8 and FIG. 9, these figures are example diagrams of data processing environments in which illustrative embodiments of FIGS. 1-7 may be implemented. FIG. 8 and FIG. 9 are only examples and are not intended to assert or imply any limitation with regard to the environments in which different embodiments may be implemented. A particular implementation may make many modifications to the depicted environments based on the following description.

FIG. 8 depicts a block diagram of a network of data processing systems in which illustrative embodiments may be implemented. Data processing environment 800 is a network of computers in which the illustrative embodiments may be implemented. Data processing environment 800 includes network 802. Network 802 is the medium used to provide communications links between various devices and computers connected together within data processing environment 800. Network 802 may include connections, such as wire, wireless communication links, or fiber optic cables.

Clients or servers are only example roles of certain data processing systems connected to network 802 and are not intended to exclude other configurations or roles for these data processing systems. Server 804 and server 806 couple to network 802 along with storage unit 808. Software applications may execute on any computer in data processing environment 800. Clients 810, 812, and 814 are also coupled to network 802. A data processing system, such as server 804 or 806, or client 810, 812, or 814 may contain data and may have software applications or software tools executing thereon.

Only as an example, and without implying any limitation to such architecture, FIG. 8 depicts certain components that are usable in an example implementation of an embodiment. For example, servers 804 and 806, and clients 810, 812, 814, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 804, 806, 810, 812, and 814 also represent example nodes in a cluster, partitions, and other configurations suitable for implementing an embodiment.

User device 832 is an example of a device described herein. For example, user device 832 can take the form of a smartphone, a tablet computer, a laptop computer, client 810 in a stationary or a portable form, or any other suitable device. User device 832 can be a mobile device implements a support system having a database, cloud-based interface, API and involving a plurality of user types and a multi-factorial pre-approval system, as well as a multi-factorial real estate analysis and purchasing support system implementing a multi-factorial property analysis system as described hereinafter. Any software application described as executing in another data processing system in FIG. 8 can be configured to execute in user device 832 in a similar manner. Any data or information stored or produced in another data processing system in FIG. 8 can be configured to be stored or produced in user device 832 in a similar manner.

An embodiment described herein can be implemented in any data processing system, such as in the form of application 805 in server 804. Various real estate related data can be present on the server and gets loaded to one or more clients 810, 812, 814. Various forms of Application 805 may also be implemented in clients 810, 812, 814. Application 805 implements an embodiment described herein in the manner of a remote server-based application or service. Application 805 may store user profile information locally, or use storage unit 808 that is accessible over network 802 to store user profile data in a secure manner within a user profiles database. Application 805 may further determine whether certain conditions described herein have been met for automatically initiating computations by, for example, device 832 or computation server 122.

Servers 804 and 806, storage unit 808, and clients 810, 812, and 814 may couple to network 802 using wired connections, wireless communication protocols, or other suitable data connectivity. Clients 810, 812, and 814 may be, for example, personal computers or network computers.

In the depicted example, server 804 may provide data, such as boot files, operating system images, and applications to clients 810, 812, and 814. Clients 810, 812, and 814 may be clients to server 804 in this example. Clients 810, 812, 814, or some combination thereof, may include their own data, boot files, operating system images, and applications. Data processing environment 800 may include additional servers, clients, and other devices that are not shown.

In the depicted example, data processing environment 800 may be the Internet. Network 802 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 800 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 800 may be used for implementing a client-server environment in which the illustrative embodiments may be implemented. A client-server environment enables software applications and data to be distributed across a network such that an application functions by using the interactivity between a client data processing system and a server data processing system. Data processing environment 800 may also employ a service-oriented architecture where interoperable software components distributed across a network may be packaged together as coherent business applications.

With reference to FIG. 9, this figure depicts a block diagram of a data processing system in which illustrative embodiments may be implemented. Data processing system 900 is an example of a computer, such as servers 804 and 806, or clients 810, 812, and 814 in FIG. 8, or another type of device in which computer usable program code or instructions implementing the processes may be located for the illustrative embodiments.

Data processing system 900 is also representative of a data processing system or a configuration therein, such as user device 832 in FIG. 8 in which computer usable program code or instructions implementing the processes of the illustrative embodiments may be located. Data processing system 900 is described as a computer only as an example, without being limited thereto. Implementations in the form of other devices, such as user device 832 in FIG. 8, may modify data processing system 900, such as by adding a touch interface, and even eliminate certain depicted components from data processing system 900 without departing from the general description of the operations and functions of data processing system 900 described herein.

In the depicted example, data processing system 900 employs a hub architecture including North Bridge and memory controller hub (NB/MCH) 902 and South Bridge and input/output (I/O) controller hub (SB/ICH) 904. Processing unit 906, main memory 908, and graphics processor 910 are coupled to North Bridge and memory controller hub (NB/MCH) 902. Processing unit 906 may contain one or more processors and may be implemented using one or more heterogeneous processor systems. Processing unit 906 may be a multi-core processor. Graphics processor 910 may be coupled to NB/MCH 902 through an accelerated graphics port (AGP) in certain implementations.

In the depicted example, local area network (LAN) adapter 912 is coupled to South Bridge and I/O controller hub (SB/ICH) 904. Audio adapter 916, keyboard and mouse adapter 920, modem 922, read only memory (ROM) 924, universal serial bus (USB) and other ports 932, and PCI/PCIe devices 934 are coupled to South Bridge and I/O controller hub 904 through bus 938. Hard disk drive (HDD) or solid-state drive (SSD) 926 and CD-ROM 930 are coupled to South Bridge and I/O controller hub 904 through bus 940. PCI/PCIe devices 934 may include, for example, Ethernet adapters, add-in cards, and PC cards for notebook computers. PCI uses a card bus controller, while PCIe does not. ROM 924 may be, for example, a flash binary input/output system (BIOS). Hard disk drive 926 and CD-ROM 930 may use, for example, an integrated drive electronics (IDE), serial advanced technology attachment (SATA) interface, or variants such as external-SATA (eSATA) and micro-SATA (mSATA). A super I/O (SIO) device 936 may be coupled to South Bridge and I/O controller hub (SB/ICH) 904 through bus 938.

Memories, such as main memory 908, ROM 924, or flash memory (not shown), are some examples of computer usable storage devices. Hard disk drive or solid-state drive 926, CD-ROM 930, and other similarly usable devices are some examples of computer usable storage devices including a computer usable storage medium.

An operating system runs on processing unit 906. The operating system coordinates and provides control of various components within data processing system 900 in FIG. 9. The operating system may be a commercially available operating system such as Microsoft® Windows® (Microsoft and Windows are trademarks of Microsoft Corporation in the United States and other countries), Linux® (Linux is a trademark of Linus Torvalds in the United States and other countries), iOS™ (iOS is a trademark of Cisco Systems, Inc. licensed to Apple Inc. in the United States and in other countries), or Android™ (Android is a trademark of Google Inc., in the United States and in other countries). An object oriented programming system, such as the Java™ programming system, may run in conjunction with the operating system and provide calls to the operating system from Java™ programs or applications executing on data processing system 900 (Java and all Java-based trademarks and logos are trademarks or registered trademarks of Oracle Corporation and/or its affiliates).

Instructions for the operating system, the object-oriented programming system, and applications or programs, such as Application 805 in FIG. 8, are located on storage devices, such as hard disk drive 926, and may be loaded into at least one of one or more memories, such as main memory 908, for execution by processing unit 906. The processes of the illustrative embodiments may be performed by processing unit 906 using computer implemented instructions, which may be located in a memory, such as, for example, main memory 908, read only memory 924, or in one or more peripheral devices.

The hardware in FIG. 8-FIG. 9 may vary depending on the implementation. Other internal hardware or peripheral devices, such as flash memory, equivalent non-volatile memory, or optical disk drives and the like, may be used in addition to or in place of the hardware depicted in FIG. 8-FIG. 9. In addition, the processes of the illustrative embodiments may be applied to a multiprocessor data processing system.

In some illustrative examples, data processing system 900 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 908 or a cache, such as the cache found in North Bridge and memory controller hub 902. A processing unit may include one or more processors or CPUs.

The depicted examples in FIG. 8-FIG. 9 and above-described examples are not meant to imply architectural limitations. For example, data processing system 900 also may be a tablet computer, laptop computer, or telephone device in addition to taking the form of a mobile device.

Turning now to FIG. 1, the illustration of FIG. 1 schematically presents an overview of a multi-factorial real estate analysis and purchasing support system, in accordance with aspects of the present disclosure. To begin using the system a user may access the system 112 by downloading it to a computer or mobile device or user device 832 or by accessing the system via the internet and may then log into the system. The log in process may involve the user selecting a unique username and password and selecting a user type. The user types may include, for example, buyer 100, lender 102, real estate agent or broker 104, home inspector 106, insurance agent 108, attorney 110, or other appropriate types. The user interface of the software may vary in available selections based on the user type selected. The user type may also be selectable or changeable based on changes or additions to the user's abilities.

As contemplated by the present disclosure, the buyer 100 may comprise the primary consumer of the multi-factorial real estate analysis and purchasing support system. The buyer 100, who may have an interest in purchasing a residential property, may begin using the system by accessing the system 112 and seeking a pre-approval 114. A lender 102, who may be registered with the system and may be licensed to perform such duties, may consult with the buyer 100 to gather information, or may analyze information provided by the buyer 100 directly to the system, to compile and present the buyer's 100 pre-approval 114. The lender 102 then saves the parameters of a buyer's pre-approval (income, assets, debt, interest rate, type of loan qualified for) into the systems data base 116.

Once the buyer 100 has been pre-approved 114 to purchase a property by the lender 102, the buyer 100 may then begin a property search 126 within the system. The property search 126 is comprised of a custom-built API 120 that is characterized of RETS (Real Estate Transaction Standard) data from MLS (Multiple Listing Service) 118, the guideline server 124 and the computation server 122 which retrieves pre-approval stats from the data base 116. In an illustrative embodiments, the guideline server is configured to keep all the rules that pertain to different types of financing, such as FHA rules that dictate that one can't get a loan over 339,400 for a single family home regardless of how high one's income is and regardless of whether one is able to afford it. Such a property search 126 may be performed by the buyer 100 directly, allowing the buyer to search for homes they can truly afford based on a real pre-approval 114. Once the buyer 100 has selected a property the buyer wishes to purchase, the buyer 100 may utilize the multi-factorial real estate analysis and purchasing support system to have the real estate agent or broker 104 send a purchase offer 128 to the property seller or its agent. If the purchase offer 128 is accepted by the property seller, the property may be placed into pending/contingent 130 status to start clearing finance contingencies with the lender 102.

After the property has been placed into pending/contingent 130 status, the buyer 100 may be required to purchase or have performed a property home inspection 132, acquire a homeowners insurance policy 134 and a property appraisal 136 which is ordered by the lender 102. The multi-factorial real estate analysis and purchasing support system may connect the buyer 100 with a home inspector 106, who may be registered with the system and may be licensed to perform such duties, to perform the home inspection 132 on the property. The multi-factorial real estate analysis and purchasing support system may also connect the buyer 100 with an insurance agent 108, who may be registered with the system and may be licensed to perform such duties, to help the buyer 100 acquire a homeowner's insurance policy 134.

The buyer 100 may track the progress of the real estate purchase transaction through the multi-factorial real estate analysis and purchasing support system, and may be made aware by the progress report of pending or unfulfilled requirements during the pending/contingent 130 status and purchase process. In this way the buyer 100 is able to track what, if any, additional tasks or services are required before a clear to close 138 may be issued and may be made aware of timelines and deadlines remaining in the purchase process. Once the required tasks have been completed, the real estate purchase transaction may be ready for the clear to close 138 and the transfer of the property to the buyer.

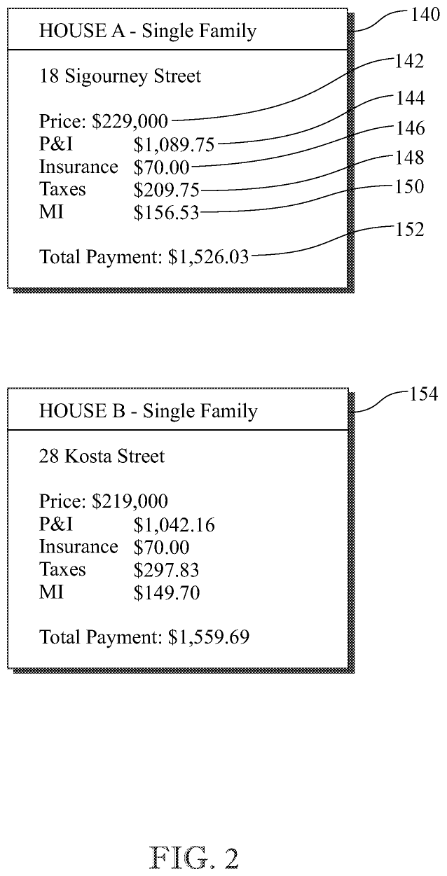

The illustration of FIG. 2 illustrates a single-family property analysis of a multi-factorial real estate analysis and purchasing support system, in accordance with aspects of the present disclosure. In more detail, the pre-approval 114 may comprise a multi-factorial analysis of the buyer's 100 ability to afford a property. Conventional/traditional methods of determinizing sales prices are performed by banks wherein since there may not be a way for a bank to know what the home a person seeking a loan will buy in the future and since every property is unique and has other costs involved, the bank simply guesses often inaccurately what the person can afford a pre-approval letter based on the guess/estimate. Whereas conventional/traditional methods of pre-approval rely on a single, estimate to determine a sales price, the multi-factorial real estate analysis and purchasing support system may consider a plurality of additional factors that are property specific including principal and interest payment 144, insurance(homeowner's/hazard insurance) 146, property taxes 148, and mortgage insurance 150 some of which comprised from a listing service such as MLS 118 to determine a total payment 152. The system may then compare the total payment 152 against a plurality of available data from the pre-approval 114 and MLS 118, separate and distinct from the price 142, to determine if a buyer 100 may be able to afford the property.

By way of a first example, a buyer 100 may have a qualifying income of $3,550 per month. Under Federal Housing Administration (FHA) guidelines the buyer's 100 mortgage payment, which may also be considered its debt to income ratio (DTI) 158, may be no more than forty-three percent (43%) of its qualifying income, resulting in a maximum monthly mortgage payment of $1,526.50 for buyer 100. The buyer 100 may, thus, be able to afford a property whose total payment 152 is equal or less than buyer's 100 maximum monthly mortgage payment.

Single Family Residence (SFR) A 140 has a price 142 of $229,000, while Single Family Residence B 154 has a price 142 of $219,000. Under today's traditional pre-approval methods if buyer 100 has a pre-approval quote of $220,000 or less, it would, logically, only be able to purchase Single Family Residence B 154. On the other hand, the multi-factorial real estate analysis and purchasing support system considers the multiple factors related to both properties to determine if buyer 100 may be able to afford either one, and may then present the viable options to the buyer 100. In the present example, the multiple factors of Single-Family Residence A 140 and Single-Family Residence B 154 with the same exact loan parameters may break down as follows:

| | SFR A | SFR B |
|---|---|---|
| Price: | $229,000 | $219,000 |
| Principal and Interest: | $1,089.75 | $1,042.16 |
| Insurance: | $70.00 | $70.00 |
| Taxes: | $209.75 | $297.83 |
| Mortgage Insurance: | $156.53 | $149.70 |
| Total Payment: | $1,526.03 | $1,559.69 |

In light of these factors it quickly becomes evident that buyer 100 is better able to afford Single Family Residence A 140, despite its higher price 142. Even though the price 142 of Single-Family Residence A 140 is beyond the pre-approval quote received by buyer 100 and higher than the price 142 of Single-Family Residence B 154, the total payment 152 is lower and is, in fact, within the limits of buyer's 100 FHA loan requirements. The buyer 100 is, thus, benefitted from attempting to purchase Single Family Residence A 140 instead of Single-Family Residence B 154, and the multi-factorial real estate analysis and purchasing support system may be able to identify this scenario and may alert a buyer 100 to such information to make a smarter better informed financial decision. This will help the buyer 100 avoid denial and loss of finances if buyer would have chosen Single-Family Residence B 154 under today's traditional pre-approval methods. In an illustrative embodiment, the total payment 152 may also accounts for non-monetary payments.

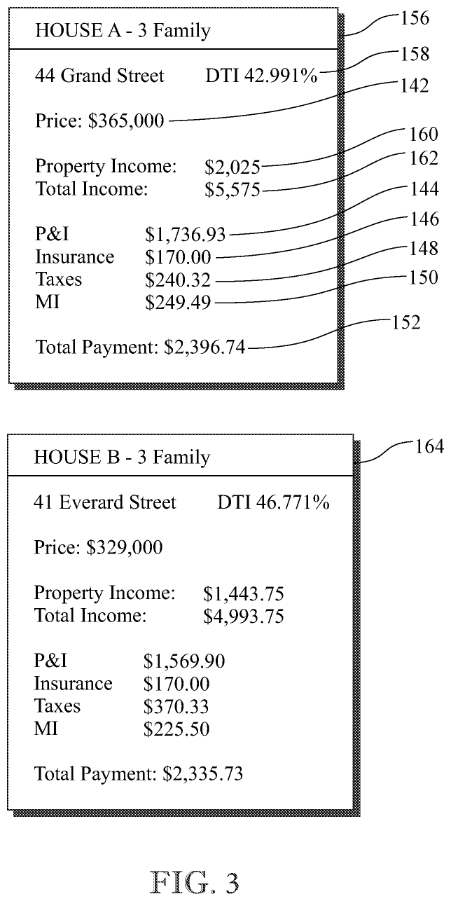

The illustration of FIG. 3 illustrates a multi-family property analysis of a multi-factorial real estate analysis and purchasing support system, in accordance with aspects of the present disclosure. The pre-approval quote of a multi-family property considers additional factors beyond those of a single-family residence analysis, which may include principal and interest payment 144, insurance 146, property taxes 148, mortgage insurance 150, property rental income 160, and total income 162 some of which comprised from MLS 118 to determine affordability. The system may then compare the total payment 152 against a plurality of available data from the pre-approval 114 and MLS 118, separate and distinct from the price 142, to determine if a buyer 100 may be able to afford the property.

By way of a second example, a buyer 100 may have a qualifying income of $3,550 per month. Under Federal Housing Administration (FHA) guidelines the buyer's 100 mortgage payment, which may also be considered its debt to income ratio (DTI) 158, may be no more than forty-three percent (43%) of its qualifying income, which may now include the property rental income 160. The buyer 100 may, thus, be able to better afford a more expensive property whose price 142 and total payment 152 is higher, but whose property rental income 160 is sufficient to offset the additional cost and reduce buyer's 100 debt to income ratio 158 below forty-three percent (43%). Under today's traditional pre-approval methods, no such system exists to allow a buyer 100 to improve their buying potential as such described.

Multi Family Residence (MFR) A 156 has a price 142 of $365,000, while Multi Family Residence B 164 has a price 142 of $329,900. If buyer 100 under today's traditional pre-approval methods has a pre-approval quote of $340,000 or less, it would, logically, only be able to purchase Multi Family Residence B 164. On the other hand, the multi-factorial real estate analysis and purchasing support system considers the multiple factors related to both properties to determine if buyer 100 may be able to afford either one, and may then present the viable options to the buyer 100. In the present example, the multiple factors of Multi Family Residence A 156 and Multi Family Residence B 164 with the same exact loan parameters may break down as follows:

| | MFR A | MFR B |
|---|---|---|
| Price: | $365,000 | $329,900 |
| Property Income: | $2,025.00 | $1,443.75 |
| Total Income: | $5,575.00 | $4,993.75 |
| Principal and Interest: | $1,736.93 | $1,569.90 |
| Insurance: | $170.00 | $170.00 |
| Taxes: | $240.32 | $370.33 |
| Mortgage Insurance: | $249.49 | $225.50 |
| Total Payment: | $2,396.74 | $2,335.73 |

In light of these factors it quickly becomes evident that buyer 100 is better able to afford Multi Family Residence A 156, despite its higher price 142. Even though the price 142 of Multi Family Residence A 156 is beyond the pre-approval quote received by buyer 100 and higher than the price 142 of Multi Family Residence B 164, the higher total payment 152 is within a debt to income (DTI) 158 ratio of forty-three percent (43%) of buyer's 100 total income 162, while the lower total payment 152 is above the debt to income (DTI) 158 ratio of forty-three percent (43%) of buyer's 100 total income. The buyer 100 is, thus, benefitted from attempting to purchase Multi Family Residence A 156 instead of Multi Family Residence B 164, and the multi-factorial real estate analysis and purchasing support system may be able to identify this scenario and may alert a buyer 100 to such information to make a smarter better informed financial decision. This will help the buyer 100 avoid denial and loss of finances if buyer would have chosen Multi Family Residence B 164 under today's traditional pre-approval methods.

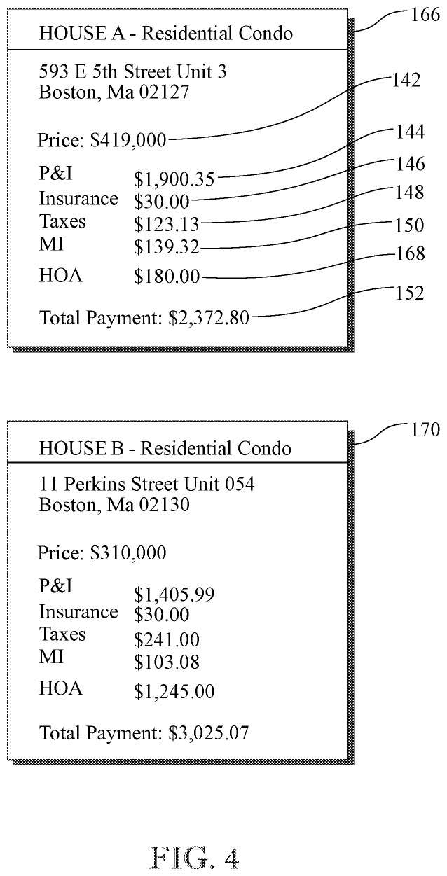

The illustration of FIG. 4 illustrates a condo property analysis of a multi-factorial real estate analysis and purchasing support system, in accordance with aspects of the present disclosure. In more detail, the pre-approval 114 may comprise a multi-factorial analysis of the buyer's 100 ability to afford a property. Whereas conventional methods of pre-approval rely on a single, estimate to determine a sales price, the multi-factorial real estate analysis and purchasing support system may consider a plurality of additional factors that are property specific including principal and interest payment 144, insurance 146, property taxes 148, HOA 168 “Homeowners Association” and mortgage insurance 150 some of which comprised from MLS 118 to determine a total payment 152. The system may then compare the total payment 152 against a plurality of available data from the pre-approval 114 and MLS 118, separate and distinct from the price 142, to determine if a buyer 100 may be able to afford the property.

By way of a first example, a buyer 100 may have a qualifying income of $5,325 per month. Conventional Conforming guidelines the buyer's 100 mortgage payment, which may also be considered its debt to income ratio (DTI) 158, may be no more than forty-five percent (45%) of its qualifying income, resulting in a maximum monthly mortgage payment of $2,396.25 for buyer 100. The buyer 100 may, thus, be able to afford a property whose total payment 152 is equal or less than buyer's 100 maximum monthly mortgage payment.

Residential Condo A 166 has a price 142 of $419,000, while Residential Condo B 170 has a price 142 of $310,000. Under today's traditional pre-approval methods if buyer 100 has a pre-approval quote of $350,000 or less, it would, logically, only be able to purchase Residential Condo B 170. On the other hand, the multi-factorial real estate analysis and purchasing support system considers the multiple factors related to both properties to determine if buyer 100 may be able to afford either one, and may then present the viable options to the buyer 100. In the present example, the multiple factors of Residential Condo A 166 and Residential Condo B 170 with the same exact loan parameters may break down as follows:

| | CONDO A | CONDO B |
|---|---|---|
| Price: | $419,000 | $310,000 |
| Principal and Interest: | $1,900.35 | $1,405.99 |
| Insurance: | $30.00 | $30.00 |
| Taxes: | $123.13 | $241.00 |
| Mortgage Insurance: | $139.32 | $103.08 |
| HOA: | $180.00 | $1,245.00 |
| Total Payment: | $2,372.80 | $3,025.07 |

In light of these factors it quickly becomes evident that buyer 100 is better able to afford Residential Condo A 166, despite its higher price 142. Even though the price 142 of Residential Condo A 166 is beyond the pre-approval quote received by buyer 100 and higher than the price 142 of Residential B 170, the total payment 152 is lower and is, in fact, within the limits of buyer's 100 Conventional Conforming loan requirements. The buyer 100 is, thus, benefitted from attempting to purchase Residential Condo A 166 instead of Residential Condo B 170, and the multi-factorial real estate analysis and purchasing support system may be able to identify this scenario and may alert a buyer 100 to such information to make a smarter better informed financial decision. This will help the buyer 100 avoid denial and loss of finances if buyer would have chosen Residential Condo B 170 under today's traditional pre-approval methods.

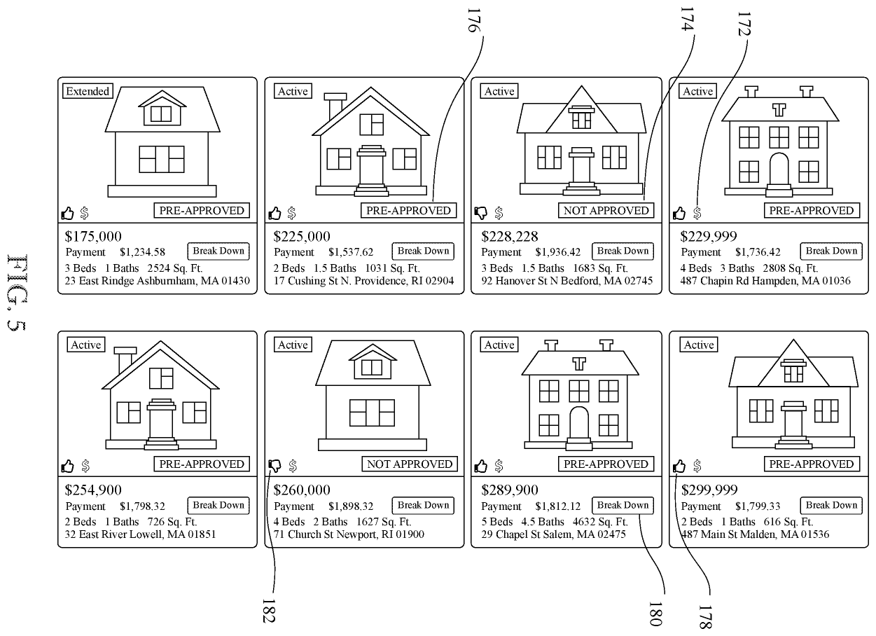

The illustration of FIG. 5 illustrates exemplary buyer search results of a multi-factorial real estate analysis and purchasing support system, in accordance with aspects of the present disclosure. The buyer 100, having been pre-approved 114, may then perform a property search 126 within the multi-factorial real estate analysis and purchasing support system, which may search the various state and national multiple listing services (MLS), to find appropriate properties listed for sale. The buyer 100 may search through available listings by setting up search parameters including location, size, bedroom and bathroom count, and listing price, and may be presented with a listing of results matching the search parameters. The multi-factorial search system also delivers a new search filter that allows a buyer to search for properties based on true payments produced by the properties according to their pre-approval 114. This allows buyers to purchase making smart financial decisions as no two properties even if priced the same have the same exact payments. The multi-factorial real estate analysis and purchasing support system may then perform the multi-factorial analysis to determine which, if at least some, of the search results the buyer 100 may be able to afford, regardless of buyer's 100 pre-approval quote or the property's listing price, as everything is based on true payments and assets.

When buyer 100 conducts a property search 126 with the various available parameters, the system conducts a full financial analysis and at a first glance shows the buyer 100 affordable properties. The dollar sign 172 is a quick indicator that the buyer 100 has sufficient funds to complete the transaction. The thumbs up 178 is a quick indicator that the buyer 100 has sufficient income to complete to purchase the property. The thumbs down 182 is a quick indicator notifying the buyer 100 that it doesn't have sufficient income to purchase the property. Pre-Approved 176 or Not Pre-approved 174 appear based on the outcome of the thumbs up 178 or thumbs down 182 as well as the dollar symbol 172 notifying the buyer 100 if that is a qualified property for it.

When buyer 100 selects a specific property from the search results the buyer may be informed of the details as to why the buyer 100 can or cannot afford the property. The system will determine why a buyer 100 cannot qualify for the specific property and adjust the price or add seller credits if additional funds are required to help a buyer 100 see their qualification limits for that particular property. The buyer 100 may also be able to adjust the property details, such as altering the offer price or adding a seller credit, to then determine if buyer 100 may be able to afford the property based on the computation. If buyer 100 finds a property upon which it wishes to make an offer, the buyer 100 may be able to generate such a purchase offer directly within the system or may be referred to a real estate agent or broker 104 who may assist.

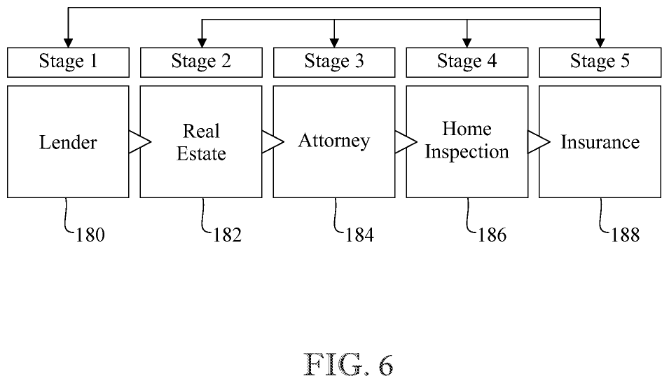

The illustration of FIG. 6 schematically presents the stages of a multi-factorial real estate analysis and purchasing support system, in accordance with aspects of the present disclosure. The first stage 180 may comprise the initial stage of using the system wherein a buyer 100 is pre-approved 114 for a home purchase by a lender 102. The system may then facilitate the buyer's 100 home buying search by combining the results of this pre-approval 114 with the system's computation server 122, guideline server 124 and API 120 to determine which homes the buyer 100 may afford. In this way the buyer 100 is not limited to considering only those properties within a traditional pre-approval.

The second stage 182 of using the system may involve the buyer 100 searching, either by itself or through a real estate agent or broker 104 through the various multiple listing services (MLS) listings to find those properties for which the buyer 100 is pre-approved 176 or not-approved 174, based on the systems computation. Once the buyer 100 has selected a property, the buyer 100 may have the system prepare any required documents for submission.

The third stage 184 of the multi-factorial real estate analysis and purchasing support system may involve having an attorney 110, who may be registered with the system and may be licensed to perform such duties, review the documents prior to submission and consult with the buyer 100 regarding any concerns it may have.

Once the property has been placed into escrow, the fourth stage 186 of using the multi-factorial real estate analysis and purchasing support system may involve the hiring of home inspectors 106, who may be registered with the system and may be licensed to perform such duties, needed to perform any tasks required by the contingencies of the purchase agreement or the escrow process.

The fifth stage 188 of the multi-factorial real estate analysis and purchasing support system may involve the procurement of appropriate insurances, homeowner's, or any other appropriate insurance, by the buyer 100. The system may connect the buyer with appropriate insurance providers, who may be registered with the system and may be licensed to perform such duties, for the acquisition of such insurance.

The multi-factorial real estate analysis and purchasing support system may further comprise a referral system, which may be a family tree referral system, which allows the various professional user types within the system to generate additional leads and track client referrals. By way of an example, a new buyer 100 introduced to the system may be asked to provide a referral source, which may be a second buyer 100. The system may automatically select the team of professionals for the new buyer 100 that matches the team who assisted the second buyer 100 in its real estate purchase transaction, so that the new buyer 100 is more likely to have a similar experience as its referral source. In this way a professional user of the system having clients of record within the system is able to generate additional client leads over time.

The multi-factorial real estate analysis and purchasing support system may further comprise a software, which may be a downloadable or cloud-based software implemented on a computing device, mobile device, or smart device.

Inputs to the system user interface may be made by any appropriate means such as, for example, text-based input or voice-based input. In an embodiment comprising text-based input, the user may type queries and commands into the user interface using any appropriate input source, such as a physical or virtual keyboard or a smartphone or tablet device connected to the system, whether physically or wirelessly. In an embodiment comprising voice-based input the user may interact with the system using a microphone, whether individually or integrated into a smartphone or tablet device, and the system may comprise speech recognition and language interpretation components to understand and interpret the input.

In one embodiment, the multi-factorial real estate analysis and purchasing support system may further comprise an electronic commerce (e-commerce) platform through which various real estate purchase-related transactions may be licensed, exchanged, or sold between users. A user of the system may associate a plurality of information with their user account, which may include payment and financial information such as, for example, credit card data, bank account data, electronic benefit transfer (EBT) data, and cryptocurrency data. In this way the system may act as a digital wallet for the user, allowing the user to access and transfer funds, as needed, with and between other users.

To protect the various user accounts, user data, and transactions stored within the system it is contemplated that the software may implement modern data security and encryption protocols. By way of example, the software may implement the advanced encryption standard (AES), the triple data encryption standard (3DES), the twofish standard, the Rivest, Shamir, Adelman standard (RSA), or any other appropriate encryption protocol. It is contemplated that the software may implement, at least, 128-bit encryption, though more difficult encryption, such as, for example, 192-bit or 256-bit, may be implemented as desired.

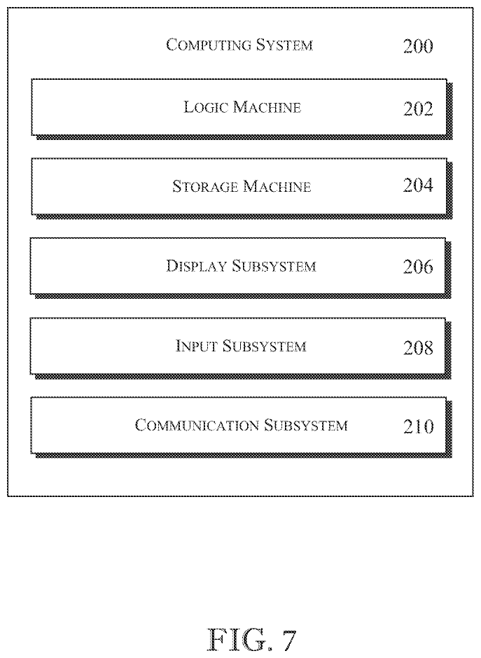

The illustration of FIG. 7 schematically presents a computing system that may represent an embodiment of the present system. In some embodiments the method is executed on a computing system such as computing system 200. For example, storage machine 204 may hold instructions executable by logic machine 202 to provide the method to users.

Display subsystem 206 may display the various elements of the method to participants. For example, display subsystem 206, storage machine 204, and logic machine 202 may be integrated such that the method may be executed while being displayed on a display screen. The input subsystem 208 may receive user input from participants to indicate the various choices or user inputs described above.

The described method may be executed, provided, or implemented to a user on one or more computing devices via a computer-program product such as via an application programming interface (API). Computing system 200 may be any appropriate computing device such as a personal computer, tablet computing device, gaming device or console, mobile computing device, etc. Computing system 200 includes a logic machine 202 and a storage machine 204. Computing system 200 may include a display subsystem 206, input subsystem 208, and communication subsystem 210.

Logic machine 202 may execute machine-readable instructions via one or more physical devices. For example, the logic machine 202 may be configured to execute instructions to perform tasks for a computer program. The logic machine may include one or more processors to execute machine-readable instructions.

Storage machine 204 includes one or more physical devices configured to hold or store instructions executable by the logic machine to implement the method. When such methods and processes are implemented, the state of storage machine 204 may be changed to hold different data. For example, storage machine 204 may include memory devices such as various hard disk drives or CD or DVD devices.

Display subsystem 206 may visually present data stored on storage machine 204. For example, display subsystem 206 may visually present data to form a graphical user interface (GUI). Input subsystem 208 may be configured to connect and receive input from devices such as a mouse, keyboard, or gaming controller. Communication subsystem 210 may be configured to enable system 200 to communicate with other computing devices. Communication subsystem 210 may include wired and/or wireless communication devices to facilitate networked communication.

As a non-limiting example, the disclosure teaches action by a processor to execute a “determining step” that cannot be done mentally, for example by determining any of the disclosed data, informatic values, or states by automatically tracking other data, informatic values, or states. For example, the disclosed systems and methods may automatically determine a second (dependent) state or value by automatically tracking a first (independent) state or value, the second state automatically depending on the first state.

The disclosure includes the practical application of a processor (logic machine), and this practical application may include the receiving of an input through a graphical user interface (GUI) such as a user selection to execute one or more tasks or operations. Such a practical application may include the automatic operation of one or more data- or state-determining tasks in response to such a user selection or user input. The practical application as such may automatically execute any of the herein operations based on automatically determining any of the disclosed values, data, informatics, or states.

It is to be understood that the disclosed systems and methods provide a specific manner of automatically executing or actualizing the disclosed tasks, operations, or methods in a manner that is an improvement over known systems and solutions. In addition to being a practical application of machines, the disclosure includes an inventive concept that is not anticipated or obvious in view of known systems and methods.

Furthermore, the systems and methods disclosed herein are configured to solve technical problems in computing in the field of the disclosure as set forth in the background section, where the problems have attributes that hinder, limit, and/or prevent the features, aspects, or elements disclosed herein from being enabled and/or implemented. Therefore, the disclosed technical solutions eliminate or alleviate these problems and positively contribute to the technical abilities of existing computing systems and methods.

Since many modifications, variations, and changes in detail can be made to the described preferred embodiments of the system, it is intended that all matters in the foregoing description and shown in the accompanying drawings be interpreted as illustrative and not in a limiting sense. Thus, the scope of the system should be determined by the appended claims and their legal equivalents.

Further, the present system may be a system, a method, and/or a computer program product. The computer program product may include a computer readable storage medium (or media) having computer readable program instructions thereon for causing a processor to carry out aspects of the present system.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present system may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present system.

Aspects of the present system are described herein with reference to flowchart illustrations and/or block diagrams of methods, apparatus (systems), and computer program products according to embodiments of the system. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present system. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising;
receiving a plurality of properties including at least one traditional property for which a buyer is approved to make a purchase and at least one other property for which the buyer is not approved to make a purchase;
defining a real affordability criteria to be satisfied;
computing a property specific mortgage payment for each member of the plurality of properties based on corresponding property specific factors in order to determine a total mortgage payment for each property in the plurality of properties; and
responsive to determining that said at least one other property for which the buyer is not approved to make a purchase is a real affordable property that meets the real affordability criteria, approving the buyer to make an offer to purchase said real affordable property.
